(19) United States
(12) Patent Application Publication
(10) Pub. No.: US 2006/0268830 A1
(43) Pub. Date: Nov. 30, 2006

(54) Wireless internet telephone

(76) Inventor: Charles E. Evans, Corvallis, OR (US)

Correspondence Address: AVAGO TECHNOLOGIES, LTD., P.O. BOX 1920, DENVER, CO, 80201-1920, US

(21) Appl. No.: 11/133,616

(22) Filed: May 20, 2005

(51) Int. Cl. H04L 12/66

(52) U.S. Cl. 370/352

(57) ABSTRACT

A wireless Internet telephone that enables placement of long-distance telephone calls via an Internet connection, thereby avoiding long-distance telephone charges associated with proprietary long-distance networks. A wireless Internet telephone according to the present teachings includes a wireless communication subsystem that enables the wireless Internet telephone to access an Internet telephony provider using a set of Internet telephony parameters.

### BACKGROUND

One type of prior wireless telephone communicates wirelessly with a base station located in a home or business. A wireless telephone that communicates with a base station located in a home or business may be referred to as a wireless handset. The base station for the wireless handset may connect to a telephone landline or private exchange located in the home or business.

Another type of prior wireless telephone communicates wirelessly via an arrangement of base stations that are located outside of a home or business. For example, a cell phone may communicate wirelessly via an arrangement of cellular base stations.

Prior wireless telephones may employ a proprietary telephone network for placing long-distance telephone calls. For example, a wireless handset may place long-distance telephone calls via a base station that connects to a landline of a telephone network in which central offices of a telephone company provide the appropriate long-distance connections. Similarly, a cell phone may place long-distance telephone calls via a long-distance telephone network of a cellular service provider.

A user of a wireless telephone that communicates via a proprietary long-distance telephone network may be subjected to a variety of charges. For example, a telephone company may impose per-minute long distance charges on a user of a wireless handset that connects to a proprietary network of a telephone company. Similarly, a cellular service provider may impose per-minute long distance charges on a user of a cell phone.

### SUMMARY OF THE INVENTION

A wireless Internet telephone is disclosed that enables placement of long-distance telephone calls via an Internet connection, thereby avoiding long-distance telephone charges associated with proprietary long-distance networks. A wireless Internet telephone according to the present teachings includes a wireless communication subsystem that enables the wireless Internet telephone to access an Internet telephony provider using a set of Internet telephony parameters.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a wireless Internet telephone according to the present teachings;

FIG. 2 illustrates communication between a pair of wireless Internet telephones according to the present teachings;

FIG. 3 shows embodiments of a wireless Internet telephone and an Internet gateway system;

FIG. 4 shows other embodiments of a wireless Internet telephone and an Internet gateway system;

FIG. 5 shows additional embodiments of a wireless Internet telephone and an Internet gateway system according to the present teachings.

### DETAILED DESCRIPTION

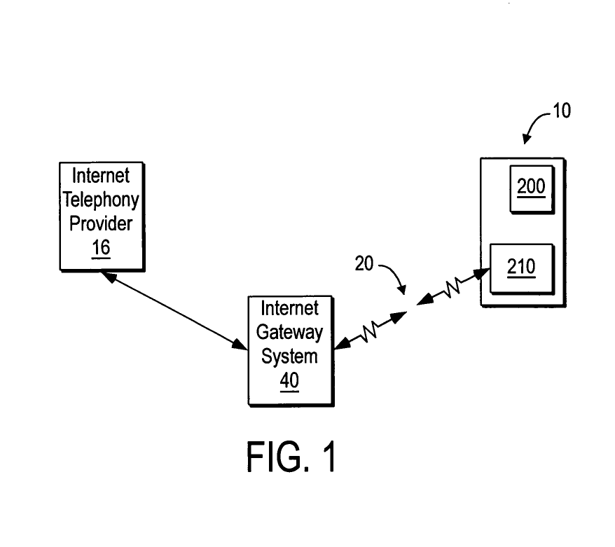

FIG. 1 shows a wireless Internet telephone 10 according to the present teachings. The wireless Internet telephone 10 includes a memory that stores a set of Internet telephony parameters 200 and further includes a wireless communication subsystem 210 that enables the wireless telephone 10 to access an Internet telephony provider 16 via an Internet gateway system 40 using the Internet telephony parameters 200. The wireless Internet telephone 10 communicates via a wireless communication link 20 to the Internet gateway system 40.

The Internet telephony parameters 200 include a web address for the Internet telephony provider 16. The Internet telephony parameters 200 may also include a set of login parameters, e.g. login name and password, to an account with the Internet telephony provider 16 that is associated with a user of the wireless Internet telephone 10. The Internet telephony parameters 200 may also include a telephone access number, e.g. a dialup number, that the wireless Internet telephone 10 uses to communicate with the Internet gateway system 40.

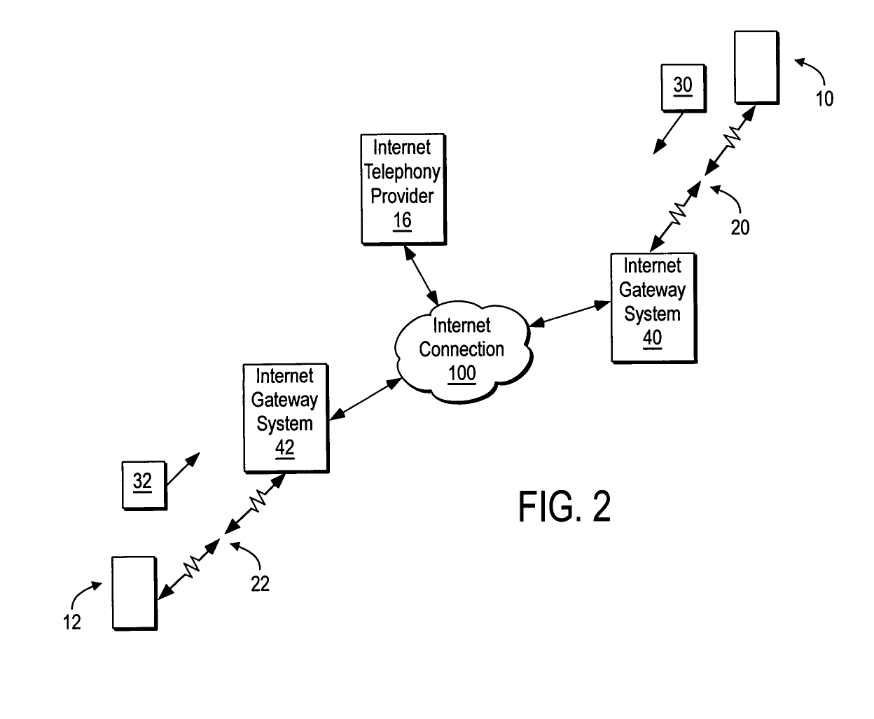

FIG. 2 illustrates communication between the wireless Internet telephone 10 and a wireless Internet telephone 12. The Internet gateway system 40 communicates with the Internet telephony provider 16 via an Internet connection 100. The wireless Internet telephone 12 communicates via a wireless communication link 22 to an Internet gateway system 42 that in turn communicates with the Internet telephony provider 16 via the Internet connection 100.

The wireless Internet telephone 10 includes circuitry for generating a data packet 30 that contains digital audio samples of speech produced by a user of the wireless Internet telephone 10. The wireless Internet telephone 10 transmits the data packet 30 to the Internet gateway system 40 via the wireless communication link 20 and the Internet gateway system 40 sends the data packet 30 to the Internet telephony provider 16 via the Internet connection 100 using Internet protocols. Similarly, the wireless Internet telephone 12 transmits a data packet 32 that contains digital audio samples of speech produced by a user of the wireless Internet telephone 12 to the Internet gateway system 42 via the wireless communication link 22 and the Internet gateway system 42 sends the data packet 32 to the Internet telephony provider 16 via the Internet connection 100 using Internet protocols.

The Internet telephony provider 16 relays the data packet 30 to the Internet gateway system 42 via the Internet connection 100 using Internet protocols. The Internet gateway system 42 passes the data packet 30 to the wireless Internet telephone 12 via the wireless communication link 22. Similarly, the Internet telephony provider 16 relays the data packet 32 to the Internet gateway system 40 via the Internet connection 100 using Internet protocols and the Internet gateway system 40 passes the data packet 32 to the wireless Internet telephone 10 via the wireless communication link 20.

The wireless Internet telephone 10 includes circuitry for rendering the audio data contained in the data packet 32 to the user of the wireless Internet telephone 10. Similarly, the wireless Internet telephone 12 includes circuitry for rendering the audio data contained in the data packet 30 to the user of the wireless Internet telephone 12.

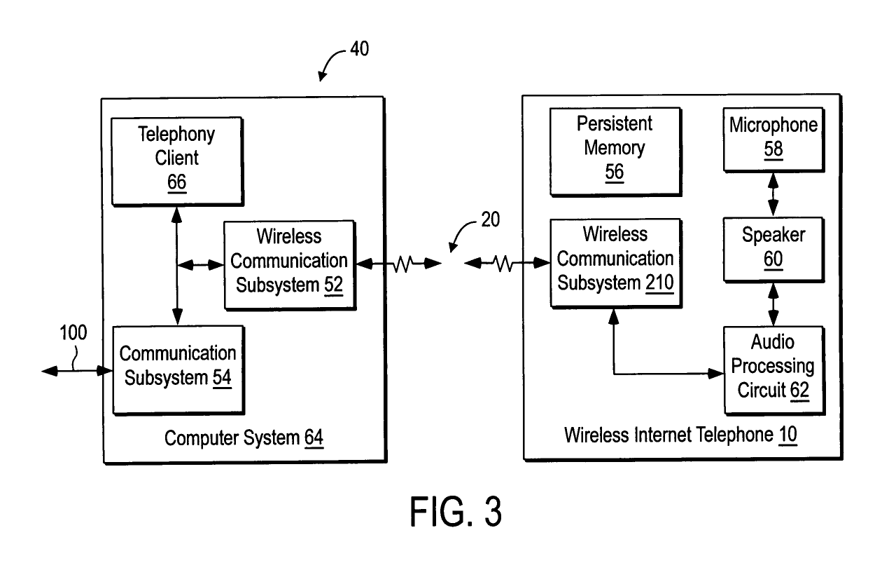

FIG. 3 shows embodiments of the wireless Internet telephone 10 and the Internet gateway system 40. The wireless Internet telephone 10 in this example includes the wireless communication subsystem 210, a persistent memory 56, a microphone 58, a speaker 60, and an audio processing circuit 62. The Internet gateway system 40 is embodied as a computer system 64 having a wireless communication subsystem 52 and a communication subsystem 54.

The wireless communication subsystems 52 and 210 provide the wireless communication link 20. The wireless communication link 20 may be a standard wireless link for a local area network, e.g. 802.11. The wireless communication subsystem 210 may be embodied in a standardized form for a standardized card slot in the wireless Internet telephone 10 or may be built in to the wireless Internet telephone 10. The wireless communication subsystem 52 may be embodied in a standardized form for a standardized card slot in the computer system 64 or may be built in to the computer system 64.

The audio processing circuit 62 digitizes audio signals obtained via the microphone 58. The audio processing circuit 62 provides the digitized audio samples to the wireless communication subsystem 210. The wireless communication subsystem 210 constructs the data packet 30 using the digitized audio samples and transmits the data packet 30 via the wireless communication link 20. Conversely, the wireless communication subsystem 210 receives the data packet 32 via the wireless communication link 20 and extracts its digitized audio samples. The wireless communication subsystem 210 provides the incoming digitized audio samples to the audio processing circuit 62. The audio processing circuit 62 renders the incoming digitized audio samples using the speaker 60.

The communication subsystem 54 of the computer system 64 provides access to the Internet connection 100, e.g. dialup or a broadband connection. The computer system 64 may be a portable computer system, e.g. laptop, handheld, in which the communication subsystem 54 supports a wireless Internet connection via a wireless Internet service provider.

The computer system 64 executes a telephony client 66 for the Internet telephony provider 16. The telephony client 66 opens/closes channels to the Internet telephony provider 16 as the user of the wireless Internet telephone 10 places and completes calls. The telephony client 66 may maintain a mapping between telephone numbers dialed by the user of the wireless Internet telephone 10 and identifiers associated with clients of the Internet telephony provider 16.

The user of the wireless Internet telephone 10 initiates a telephone call by dialing a number on a keypad of the wireless Internet telephone 10. In response, the wireless Internet telephone 10 transmits the dialed telephone number along with the Internet telephony parameters 200 contained in the persistent memory 56 to the computer system 64 via the wireless communication link 20. The telephony client 66 uses the Internet telephony parameters 200, e.g. web address for the Internet telephony provider 16 and login parameters for an account with the Internet telephony provider 16, to open a channel to the Internet telephony provider 16. The telephony client 66 relays telephony data packets, e.g. the data packets 30-32 between the Internet telephony provider 16 and the wireless Internet telephone 10 during an Internet telephone call.

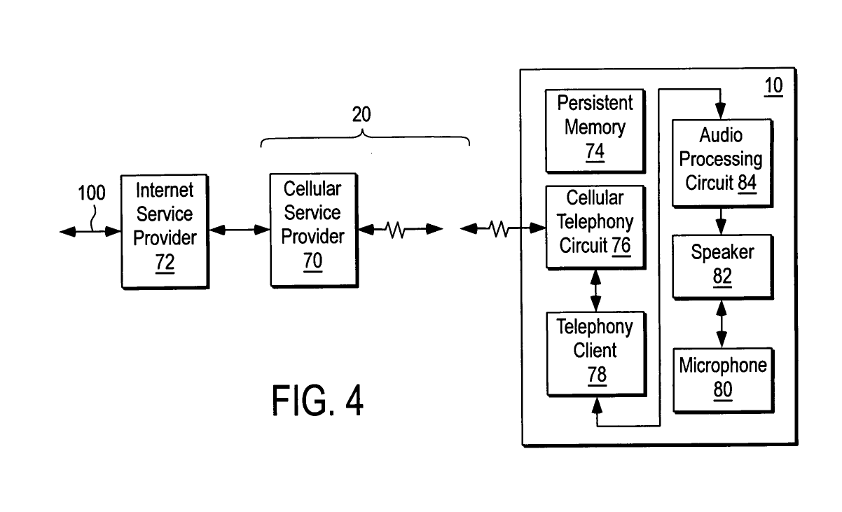

FIG. 4 shows other embodiments of the wireless Internet telephone 10 and the Internet gateway system 40. The wireless Internet telephone 10 in this example is a cell phone that includes a persistent memory 74, a microphone 80, a speaker 82, and an audio processing circuit 84. The wireless communication subsystem 210 is embodied as a cellular telephony circuit 76 that provides the wireless communication link 20 via a cellular service provider 70. The Internet gateway system 40 in this example is embodied as an internet service provider 72 that provides the Internet connection 100.

The wireless Internet telephone 10 embodied as a cell phone includes a processor that executes a telephony client 78 for the Internet telephony provider 16. The telephony client 78 opens/closes channels to the Internet telephony provider 16 as the user of the wireless Internet telephone 10 places and completes calls. The telephony client 78 may maintain a mapping between telephone numbers dialed by a user and identifiers associated with clients of the Internet telephony provider 16.

The user initiates a telephone call by dialing a number on a keypad of the cell phone. In response, the telephony client 78 initiates a dialup connection to the internet service provider 72. A telephone number for the dialup connection may be stored in the persistent memory 74. The telephony client 78 uses the Internet telephony parameters 200 contained in the persistent memory 74, e.g. web address for the Internet telephony provider 16 and login parameters for an account with the Internet telephony provider 16 to open a channel to the Internet telephony provider 16.

The audio processing circuit 84 digitizes audio signals obtained via the microphone 80 and provides the digitized audio samples to the telephony client 78. The telephony client 78 constructs the data packet 30 using the digitized audio samples and provides the data packet 30 to the cellular telephony circuit 76 for transmission to the cellular service provider 70.

The cellular telephony circuit 76 receives the data packet 32 from the cellular service provider 70 and provides the data packet 32 to the telephony client 78. The telephony client 78 extracts the audio samples from the data packet 32 and provides the audio samples to the audio processing circuit 84 which renders the incoming digitized audio samples using the speaker 80.

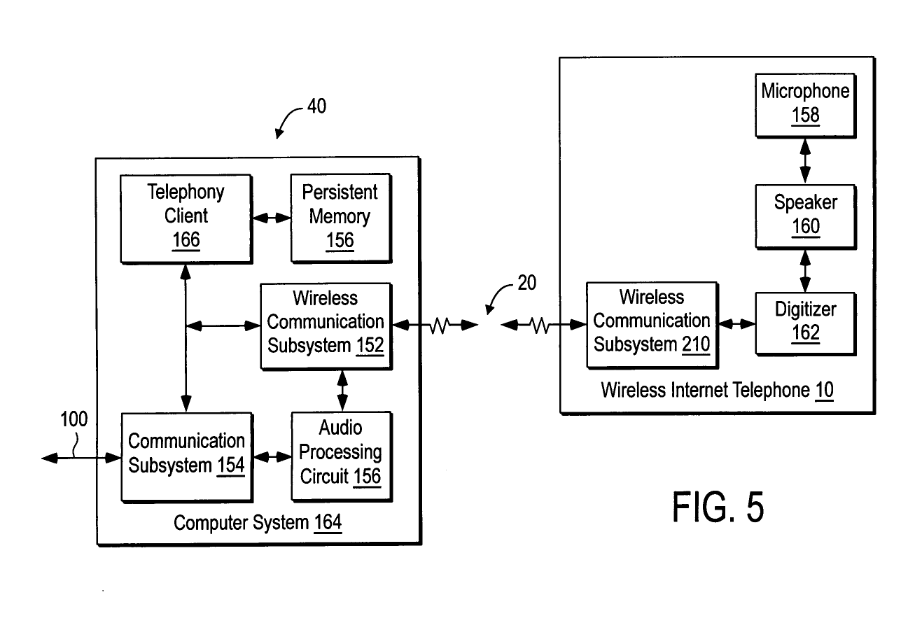

FIG. 5 shows additional embodiments of the wireless Internet telephone 10 and the Internet gateway system 40. The wireless Internet telephone 10 in this example includes the wireless communication subsystem 210, a microphone 158, a speaker 160, and a digitizer 162. The Internet gateway system 40 is embodied as a computer system 164 having a wireless communication subsystem 152 and a communication subsystem 154. The wireless communication subsystems 152 and 210 provide the wireless communication link 20.

The computer system 164 in this embodiment includes a persistent memory 156 that holds the Internet telephony parameters 200. The computer system 164 includes an audio processing circuit 156 that generates the data packet 30 and that extracts audio data from the data packet 32.

The digitizer 162 digitizes audio signals from the microphone 158. The digitizer 162 provides the digitized audio samples to the wireless communication subsystem 210 and the wireless communication subsystem 210 transmits the digitized audio samples via the wireless communication link 20. Conversely, the wireless communication subsystem 210 receives digitized audio samples via the wireless communication link 20 and provides the incoming digitized audio samples to the digitizer 162 which renders the incoming digitized audio samples using the speaker 60.

The communication subsystem 154 of the computer system 164 provides access to the Internet connection 100. The computer system 164 executes a telephony client 166 for the Internet telephony provider 16. The telephony client 166 opens/closes channels to the Internet telephony provider 16 as the user of the wireless Internet telephone 10 places and completes calls. The telephony client 166 may maintain a mapping between telephone numbers dialed by the user of the wireless Internet telephone 10 and identifiers associated with clients of the Internet telephony provider 16.

The user of the wireless Internet telephone 10 initiates a telephone call by dialing a number on a keypad of the wireless Internet telephone 10. In response, the wireless Internet telephone 10 transmits the dialed telephone number to the computer system 164 via the wireless communication link 20. The telephony client 166 uses the Internet telephony parameters 200 from the persistent memory 156 to open a channel to the Internet telephony provider 16. The telephony client 166 relays telephony data packets, e.g. the data packets 30-32 between the Internet telephony provider 16 and the audio processing circuit 156 during an Internet telephone call and the audio processing circuit 156 relays the digitized audio data for the data packets via the wireless communication link 20.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A wireless Internet telephone comprising a wireless communication subsystem that enables the wireless telephone to access an Internet telephony provider using a set of Internet telephony parameters.

2. The wireless Internet telephone of claim 1, further comprising a persistent memory for holding the Internet telephony parameters.

3. The wireless Internet telephone of claim 1, wherein the Internet telephony parameters include a web address of the Internet telephony provider.

4. The wireless Internet telephone of claim 3, wherein the Internet telephony parameters include a login name for an account with the Internet telephony provider.

5. The wireless Internet telephone of claim 4, wherein the Internet telephony parameters include a password to the account.

6. The wireless Internet telephone of claim 1, wherein the wireless communication subsystem is adapted to communicate on a local area network.

7. The wireless Internet telephone of claim 1, wherein the wireless communication subsystem is adapted to communicate on a cellular network.

8. The wireless Internet telephone of claim 1, wherein the Internet telephony parameters include a telephone number for an Internet service provider.

9. A wireless Internet telephony system, comprising:
wireless telephone;
gateway system that enables the wireless telephone to access an Internet telephony provider using a set of Internet telephony parameters.

10. The wireless Internet telephony system of claim 9, wherein the wireless telephone includes a persistent memory for holding the Internet telephony parameters.

11. The wireless Internet telephony system of claim 9, wherein the gateway includes a persistent memory for holding the Internet telephony parameters.

12. The wireless Internet telephony system of claim 9, wherein the Internet telephony parameters include a web address of the Internet telephony provider.

13. The wireless Internet telephony system of claim 12, wherein the Internet telephony parameters include a login name for an account with the Internet telephony provider.

14. The wireless Internet telephony system of claim 13, wherein the Internet telephony parameters include a password to the account.

15. The wireless Internet telephony system of claim 9, wherein the wireless telephone includes a wireless communication subsystem that is adapted to communicate on a local area network.

16. The wireless Internet telephony system of claim 15, wherein the gateway system is a computer system on the local area network.

17. The wireless Internet telephony system of claim 9, wherein the wireless telephone is a cell phone.

18. The wireless Internet telephony system of claim 17, wherein the Internet telephony parameters include a telephone number for an Internet service provider.
